(19) United States
(12) Patent Application Publication
(10) Pub. No.: US 2024/0157697 A1
(43) Pub. Date: May 16, 2024

(54) IMAGE FORMING APPARATUS, IMAGE FORMING METHOD, AND NON-TRANSITORY RECORDING MEDIUM

(71) Applicant: Atsushi HADA, Kanagawa (JP)

(72) Inventor: Atsushi HADA, Kanagawa (JP)

(73) Assignee: Ricoh Company, Ltd., Tokyo (JP)

(21) Appl. No.: 18/487,422

(22) Filed: Oct. 16, 2023

(30) Foreign Application Priority Data
Nov. 14, 2022 (JP) 2022-181821
Jul. 18, 2023 (JP) 2023-117081

(51) Int. Cl. B41J 2/045; B41J 2/465

(52) U.S. Cl. CPC B41J 2/04541; B41J 2/04558; B41J 2/04561; B41J 2/465

(57) ABSTRACT

An image forming apparatus, an image formation method, and a non-transitory recording medium. The image forming apparatus acquires print data, converts the print data into ejection data to be used by the recording head to eject ink, applies to the ejection data, a correction mask pattern to change a manner of ink ejection for each nozzle of a nozzle row, the nozzle row including a plurality of nozzles arranged in a sub scanning direction of the recording head, and causes each nozzle of the recording head to eject ink onto the recording medium based on the ejection data to which the correction mask pattern is applied.

### CROSS-REFERENCE TO RELATED APPLICATIONS

This patent application is based on and claims priority pursuant to 35 U.S.C. § 119(a) to Japanese Patent Applications No. 2022-181821, filed on Nov. 14, 2022, and No. 2023-117081, filed on Jul. 18, 2023, in the Japan Patent Office, the entire disclosure of which is hereby incorporated by reference herein.

### BACKGROUND

### Technical Field

The present disclosure relates to an image forming apparatus, an image formation method, and a non-transitory recording medium.

### Related Art

Inkjet printers that eject ink onto a recording medium to form an image while relatively moving a recording head in which a plurality of nozzles for ejecting ink are arranged and a recording medium are known. In such an inkjet printer, the image is formed by alternately repeating a main scanning operation in which ink is ejected from the nozzles onto the recording medium while moving the recording head in the main scanning direction and a sub scanning operation in which the recording head or the recording medium is moved in the sub scanning direction. In this case, a printed image formed by the inkjet printer is made up of a large number of dots formed by ejecting ink from a nozzle row. For this reason, in a case a dot formation position, which is a landing position of the ink on the recording medium, deviates from a predetermined target position, a clear printed image is not drawn on the recording medium such as paper. Techniques are known for correcting deviation in ink landing position caused by poor conveyance accuracy of the recording medium or nozzle ejection characteristics of the recording head.

### SUMMARY

Embodiments of the present disclosure describe an image forming apparatus, an image formation method, and a non-transitory recording medium.

According to one embodiment, the image forming apparatus acquires print data, converts the print data into ejection data to be used by the recording head to eject ink, applies to the ejection data, a correction mask pattern to change a manner of ink ejection for each nozzle of a nozzle row, the nozzle row including a plurality of nozzles arranged in a sub scanning direction of the recording head, and causes each nozzle of the recording head to eject ink onto the recording medium based on the ejection data to which the correction mask pattern is applied.

According to one embodiment, the image forming method performed by the image forming apparatus includes, acquiring print data, converting the print data into ejection data to be used by a recording head of the image forming apparatus to eject ink, applying to the ejection data, a correction mask pattern to change a manner of ink ejection for each nozzle of a nozzle row, the nozzle row including a plurality of nozzles arranged in sub scanning direction of the recording head, and causing each nozzle of the recording head to eject ink onto a recording medium based on the ejection data to which the correction mask pattern is applied, to form an image on the recording medium.

According to one embodiment, the non-transitory recording medium storing a plurality of instructions which, when executed by one or more processors on an image forming apparatus, causes the processors to perform an image forming method including, acquiring print data, converting the print data into ejection data to be used by a recording head of the image forming apparatus to eject ink, applying to the ejection data, a correction mask pattern to change a manner of ink ejection for each nozzle of a nozzle row, the nozzle row including a plurality of nozzles arranged in sub scanning direction of the recording head, and causing each nozzle of the recording head to eject ink onto a recording medium based on the ejection data to which the correction mask pattern is applied, to form an image on the recording medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an outer appearance of an image forming apparatus according to embodiments of the present disclosure;

FIG. 2 is a diagram illustrating an example of a bottom view of a carriage of an image forming apparatus according to embodiments of the present disclosure;

FIG. 3 is a block diagram illustrating a hardware configuration of the image forming apparatus according to embodiments of the present disclosure;

FIG. 4 is a diagram illustrating ink landing positions in an image forming apparatus in the related art;

FIG. 5 is a diagram illustrating an operation of correcting deviation in the ink landing positions in the image forming apparatus;

FIG. 6 is a block diagram illustrating an example of a functional configuration of the image forming apparatus according to embodiments of the present disclosure;

FIG. 7 is a diagram illustrating an operation of correcting the deviation in the ink landing positions in the image forming apparatus according to embodiments of the present disclosure;

FIG. 8 is a diagram illustrating an example of a drive waveform of a recording head used to correct the deviation in the ink landing positions in the image forming apparatus according to embodiments of the present disclosure;

FIG. 9 is a flow chart illustrating an example of an overall operation of the image forming apparatus according to embodiments of the present disclosure;

FIG. 10 is a diagram illustrating an operation of correcting the deviation in the ink landing positions in the image forming apparatus according to a modification 1 of the present disclosure;

FIG. 11 is a diagram illustrating an operation for correcting variation in an ink diameter in the image forming apparatus according to a modification 2; and

FIG. 12 is a diagram illustrating an example of a recording head drive waveform used to correct variation in the ink diameter in the image forming apparatus according to the modification 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of an image forming apparatus, an image formation method, and a non-transitory recording medium according to the present disclosure are described below in detail with reference to the drawings. The present disclosure, however, is not limited to the following embodiments, and the constituent elements of the following embodiments include elements that are easily conceived by those skilled in the art, those being substantially the same ones, and those being within equivalent ranges. Furthermore, various omissions, substitutions, changes and combinations of the constituent elements can be made without departing from the gist of the following embodiments.

In addition, computer software refers to programs related to computer operations and other information used for processing by computers that are equivalent to programs (hereinafter, computer software is referred to as software). An application program, which may be simply referred to as “application”, is a general term for any software used to perform certain processing. An operating system (hereinafter simply referred to as an “OS”) is software for controlling a computer, such that software, such as application, is able to use computer resource. The OS controls basic operation of the computer such as input or output of data, management of hardware such as a memory or a hard disk, or processing to be executed.

The application software operates by utilizing functions provided by the OS. The program is a set of instructions for causing the computer to perform processing to have a certain result. While data to be used in processing according to the program is not a program itself, such data may define processing to be performed by the program such that the data to be used in processing may be interpreted as equivalent to the program. For example, a data structure, which is a logical structure of data described by an interrelation between data elements, may be interpreted as equivalent to the program.

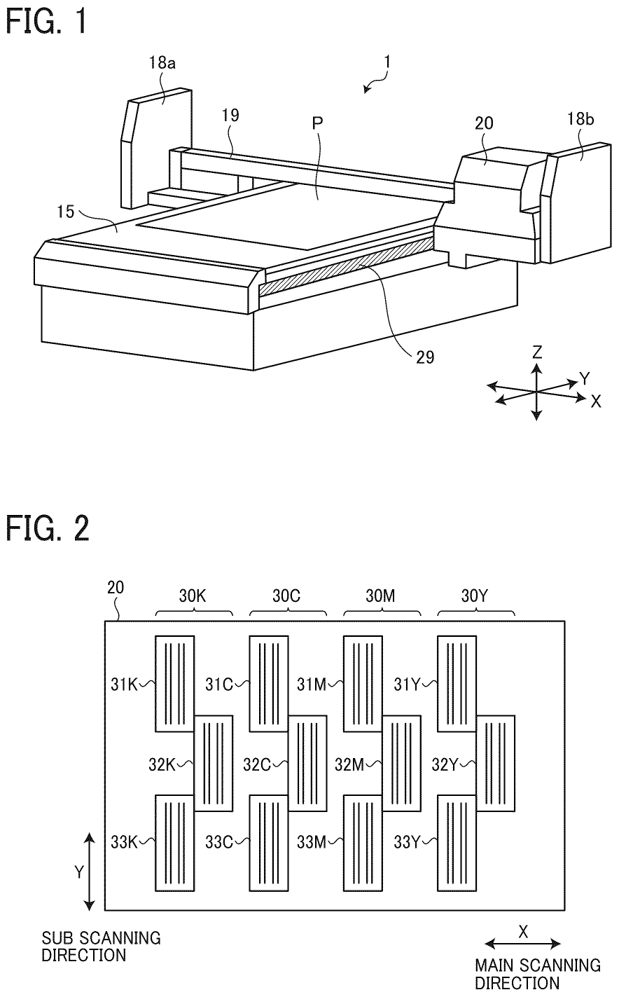

FIG. 1 is a diagram illustrating an example of an outer appearance of an image forming apparatus according to the present embodiment. FIG. 2 is a diagram illustrating an example of a bottom view of a carriage of an image forming apparatus according to the present embodiment. An example of a schematic configuration of an image forming apparatus 1 according to the present embodiment is described with reference to FIGS. 1 and 2.

The image forming apparatus 1 illustrated in FIG. 1 is a serial type image forming apparatus that forms an image on a recording medium such as paper by ejecting ink from a recording head mounted on a carriage. As illustrated in FIG. 1, the image forming apparatus 1 includes a platen 15, side plates 18a and 18b, a guide rod 19, a carriage 20, and a guide rail 29.

The platen 15 is an example of table member on which a recording medium P, to which ink is ejected (printed), is placed.

The left and right side plates 18a and 18b are examples of plate members that support the carriage 20 together with a guide rod 19 that spans both sides. Further, the side plates 18a and 18b have a function of regulating movement of the carriage in the main scanning direction (X direction illustrated in FIG. 1).

The guide rod 19 is an example of member that is bridged between the side plates 18a and 18b, supports the carriage 20, and guides the movement of the carriage 20 in the main scanning direction.

The carriage 20 is an example of member that has a recording head provided that ejects ink and moves back and forth in the main scanning direction along the guide rod 19. Further, the carriage 20 is also movable in the vertical direction (Z direction illustrated in FIG. 1) by a lifting mechanism. As illustrated in FIG. 2, the carriage 20 includes a recording head 30K, a recording head 30C, a recording head 30M, and a recording head 30Y. As illustrated in FIG. 2, the recording heads 30K, 30C, 30M, and 30Y are arranged in the main scanning direction (X direction) and are arranged to eject ink downward in the Z direction.

The recording head 30K includes a recording head 31K, a recording head 32K, and a recording head 33K, each of which ejects K (black) ink. As illustrated in FIG. 2, the recording heads 31K, 32K, and 33K are arranged at different positions in the sub scanning direction, and each recording head includes a plurality of nozzles arranged in the sub scanning direction.

The recording head 30C includes a recording head 31C, a recording head 32C, and a recording head 33C, each of which ejects C (cyan) ink. As illustrated in FIG. 2, the recording heads 31K, 32K, and 33K are arranged at different positions in the sub scanning direction, and each recording head includes a plurality of nozzles arranged in the sub scanning direction.

The recording head 30M includes a recording head 31M, a recording head 32M, and a recording head 33M, each ejects M (magenta) ink. As illustrated in FIG. 2, the recording heads 31K, 32K, and 33K are arranged at different positions in the sub scanning direction, and each recording head includes a plurality of nozzles arranged in the sub scanning direction.

The recording head 30Y includes a recording head 31Y, a recording head 32Y, and a recording head 33Y, each of which ejects Y (yellow) ink. As illustrated in FIG. 2, the recording heads 31K, 32K, and 33K are arranged at different positions in the sub scanning direction, and each recording head includes a plurality of nozzles arranged in the sub scanning direction.

Note that the recording heads 30K, 30C, 30M, and 30Y each includes three recording heads disposed at different positions in the sub scanning direction, but are not limited to this example, and may include one, two, or four or more recording heads.

Further, the recording heads 30K, 30C, 30M, and 30Y may be simply referred to as “recording head 30” when referring to any of the recording heads or when referring to the recording heads collectively. Further, the recording heads 31K to 33K, 31C to 33C, 31M to 33M, and 31Y to 33Y may also be simply referred to as “recording head 30” when referring to any recording head or when collectively referring to the recording heads.

Furthermore, the ink ejected from the recording head 30 is not limited to the cyan, yellow, magenta, and black (CMYK) color inks as described above, but may include, for example, transparent ink, metallic color ink, fluorescent ink, or the like.

Each recording head 30 includes a piezoelectric element as a pressure generator, contracts in response to a drive signal, and ejects ink due to the pressure change accompanying the contraction.

The guide rail 29 is an example of rail member extending in the sub scanning direction below the platen 15. The side plates 18a, 18b, guide rod 19, and carriage 20 integrally move back and forth along the guide rail 29 in the sub scanning direction.

In the example of the image forming apparatus 1 illustrated in FIG. 1, a configuration is illustrated in which the carriage 20 reciprocates in the main scanning direction and the sub scanning direction to eject ink onto the recording medium P. However, the present disclosure is not limited to this example. For example, the image forming apparatus 1 may have a configuration in which the carriage 20 is moved in the main scanning direction and the recording medium P is conveyed in the sub scanning direction, or a configuration in which the recording medium P is moved in the main scanning direction and the sub scanning direction.

Furthermore, although the image forming apparatus 1 is the serial type image forming apparatus based on the carriage 20, but the present disclosure is not limited to this example, and may be a line type image forming apparatus that performs printing in a single path.

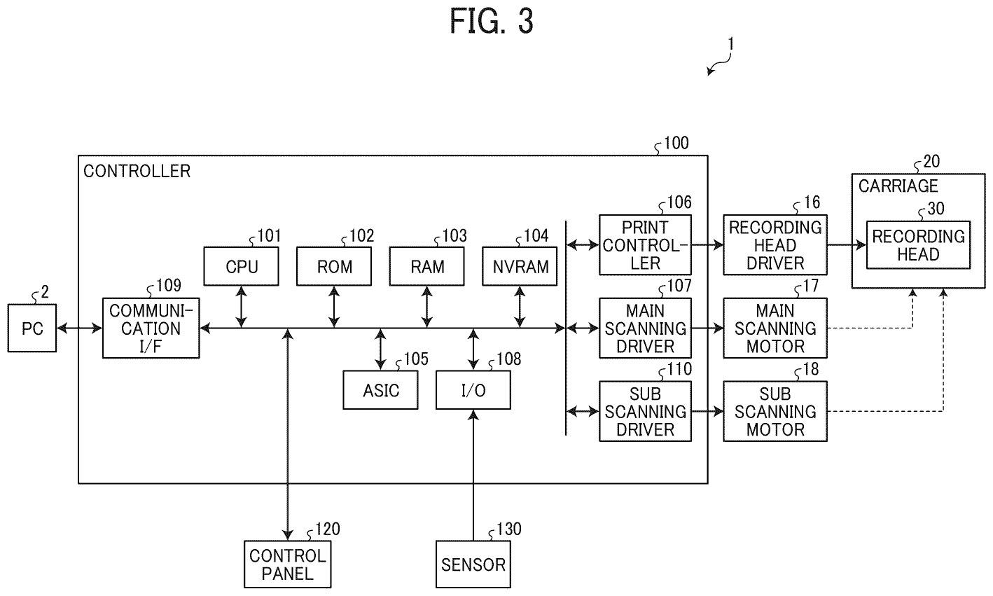

FIG. 3 is a diagram illustrating an example of a hardware configuration of the image forming apparatus according to the present embodiment. The hardware configuration of the image forming apparatus 1 according to the present embodiment is described with reference to FIG. 3.

As illustrated in FIG. 3, the image forming apparatus 1 includes a controller 100, a control panel 120, a sensor 130, a recording head driver 16, a main scanning motor 17, and a sub scanning motor 18.

The controller 100 controls an overall operation and various processes of the image forming apparatus 1. The controller 100 includes a central processing unit (CPU) 101, a read only memory (ROM) 102, a random access memory (RAM) 103, and a non-volatile random access memory (NVRAM) 104, an application-specific integrated circuit (ASIC) 105, a print controller 106, a main scanning driver 107, an input/output (I/O) 108, a communication interface (UF) 109, and a sub scanning driver 110.

The CPU 101 is a processor that performs overall control of the image forming apparatus 1. The ROM 102 is a nonvolatile storage device that stores fixed data such as programs executed by the CPU 101.

The RAM 103 is a volatile storage device that serves as a work area for arithmetic processing by the CPU 101. Further, the RAM 103 temporarily stores image data and the like.

The NVRAM 104 is a nonvolatile storage device that retains data, programs, and the like even while the image forming apparatus 1 is powered off.

The ASIC 105 is an integrated circuit that processes various signal processes for image data, image processing such as sorting, and other input and output signals for controlling the entire image forming apparatus 1.

The print controller 106 is a control circuit that controls the ejection operation of the recording head 30 through the recording head driver 16 under control of the CPU 101. The print controller 106 transfers data for driving the recording head 30 to the recording head driver 16. For example, the print controller 106 transfers ejection data as serial data, and outputs a transfer clock, a latch signal, a control signal, and the like to transfer the ejection data to the recording head driver 16. The recording head driver 16 drives the recording head 30 to eject ink by selectively applying a drive pulse forming a voltage drive waveform corresponding to the ejection data received from the print controller 106, to the pressure generator of the recording head 30 based on ejection data corresponding to one line of the recording head 30 that is input serially.

The main scanning driver 107 is a drive circuit that controls the operation of the main scanning motor 17 under the control of the CPU 101. The main scanning motor 17 is a motor that moves the carriage 20 in the main scanning direction under the control of the main scanning driver 107.

The I/O 108 is an interface circuit for acquiring information from the sensor 130 and extracting information used for controlling each part of the image forming apparatus 1. The sensor 130 is, for example, an optical sensor that reads a printed image formed on the recording medium P, a temperature sensor that detects the temperature of a heater during printing, or the like.

The communication I/F 109 is an interface circuit that transmits and receives data (print data, etc.) and signals to and from a personal computer (PC) 2. Specifically, the communication OF 109 transmits and receives data and signals from the PC 2 through a cable or a network. The communication OF 109 communicates with the PC 2 through the network, for example, in compliant with Transmission Control Protocol (TCP)/Internet Protocol (IP). The print data stored in a reception buffer of the communication OF 109 is analyzed by the CPU 101, subjected to image processing and data sorting processing by the ASIC 105, and transferred to the recording head driver 16 as the ejection data by the print controller 106.

The sub scanning driver 110 is a drive circuit that controls a rotational drive of the sub scanning motor 18 under the control of the CPU 101. The sub scanning motor 18 is a motor that rotates under the control of the sub scanning driver 110 to integrally move the side plates 18a, 18b, the guide rod 19, and the carriage 20 back and forth along the guide rail 29.

The control panel 120 is a device such as a touch panel that inputs and outputs various information.

The hardware configuration of the image forming apparatus 1 illustrated in FIG. 3 is an example and may not include all the components illustrated in FIG. 3 or may include other components.

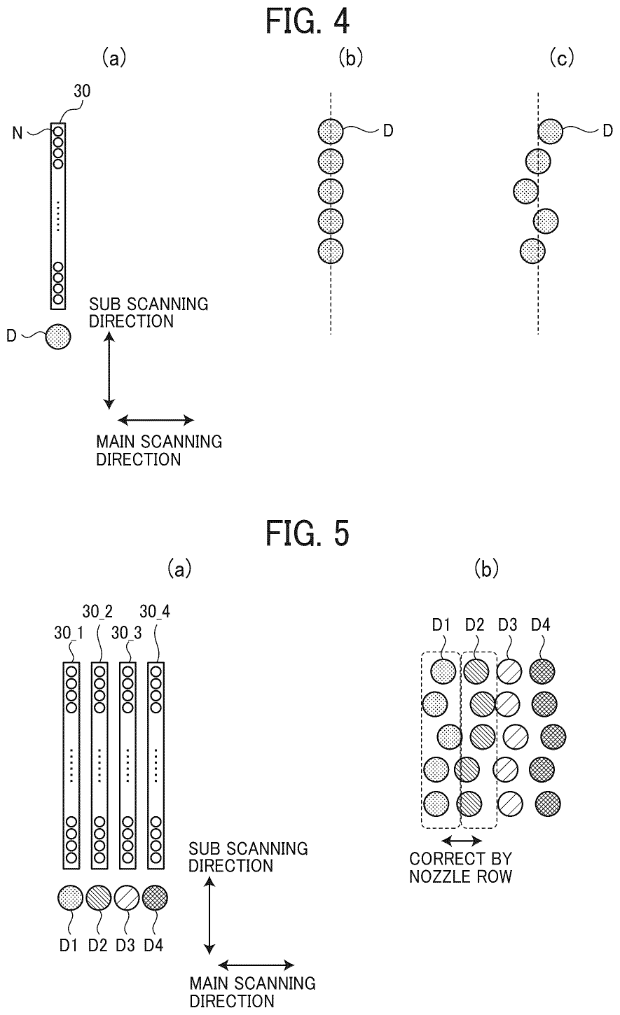

FIG. 4 is a diagram illustrating ink landing positions in an image forming apparatus in the related art. FIG. 5 is a diagram illustrating an operation of correcting deviation in the ink landing positions in the image forming apparatus of FIG. 4. An inconvenience with the image forming apparatus in the related art is described below with reference to FIGS. 4 and 5.

With reference to FIG. 4, the landing positions of ink ejected from the nozzles included in the recording head 30 is described. As illustrated in FIG. 4(a), the recording head 30 includes the nozzle row in which a plurality of nozzles N are arranged in the sub scanning direction, as described above. The ink is ejected from each nozzle N, and dots formed by the ink landing on the recording medium P is referred to as dots D.

Ideally, each dot D formed by ink ejected from the nozzle row of the recording head should be formed in a straight line in the sub scanning direction, as illustrated in FIG. 4(b), in the case the ink is ejected from all nozzles N in the nozzle row at the same time. However, in reality, the dots D are not lined up in the straight line and the landing positions are deviated due to variation in the ejection characteristics or formation positions of each nozzle N in the nozzle row, in the case the ink is ejected from all nozzles N in the nozzle row at the same time, as illustrated in FIG. 4(c). For example, fine letters or thin lines are blurred due to the deviation in the landing positions of the ink as described above, and the image quality level of the print image formed on the recording medium P is deteriorated.

For example, as illustrated in FIG. 5(a), in the case the recording head 30 includes recording heads 30_1, 30_2, 30_3, and 30_4 that eject different inks, the dots formed by the ink ejected from each recording head are referred to as dots D1, D2, D3, and D4.

In the case the ink landing position is corrected for each nozzle row of the recording heads 30_1, 30_2, 30_3, and 30_4, as in the image forming apparatus in the related art, the ink landing position in the main scanning direction is corrected but the deviation of the landing position for each nozzle is not corrected leaving the ink dots not aligned in a straight line as illustrated in FIG. 5(b).

Hereinafter, in order to deal with above inconvenience, detailed functions of the image forming apparatus 1 that corrects the deviation of the landing position for each nozzle is described below.

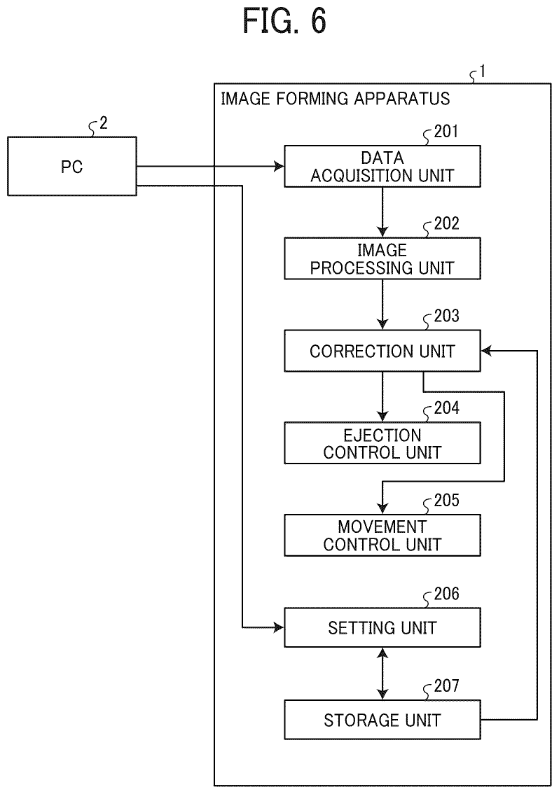

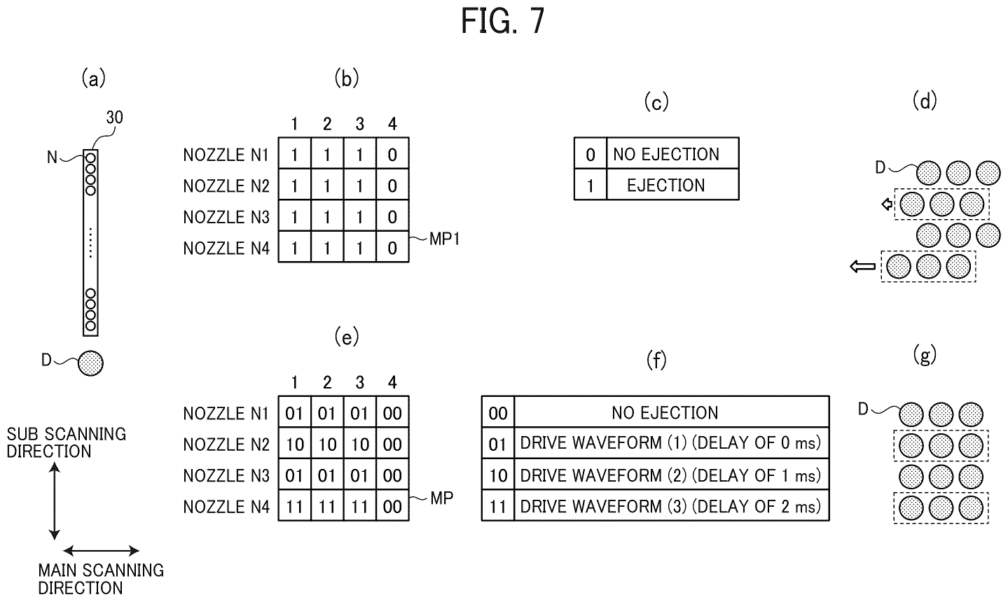

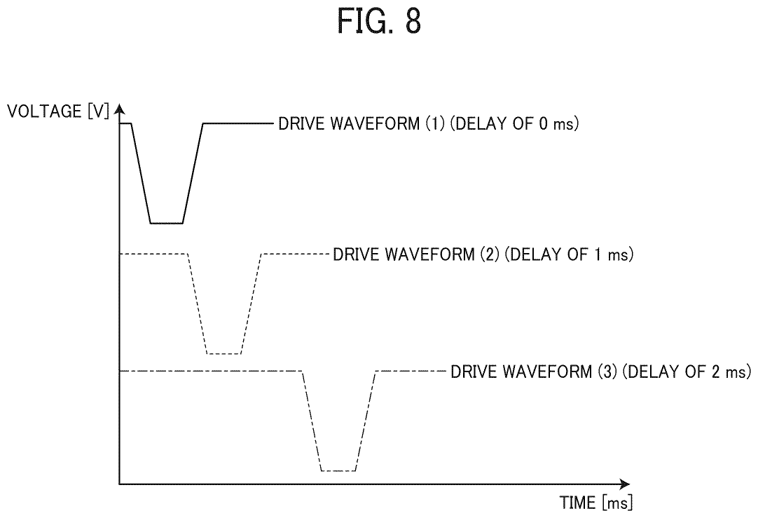

FIG. 6 is a block diagram illustrating an example of a functional configuration of the image forming apparatus according to the present embodiment. FIG. 7 is a diagram illustrating an operation of correcting the deviation in the ink landing position in the image forming apparatus according to the present embodiment. FIG. 8 is a diagram illustrating an example of a drive waveform of the recording head used to correct the deviation in the ink landing position in the image forming apparatus according to the present embodiment. A configuration and operation of functional blocks of the image forming apparatus 1 according to the present embodiment is described below with reference to FIGS. 6 to 8.

As illustrated in FIG. 6, the image forming apparatus 1 includes a data acquisition unit 201 (acquisition unit), an image processing unit 202 (an example of a conversion unit), a correction unit 203, an ejection control unit 204, and a movement control unit 205, a setting unit 206 and a storage unit 207.

The data acquisition unit 201 is a functional unit that acquires print data from the PC 2 through the communication OF 109.

The image processing unit 202 is a functional unit that performs predetermined data processing such as CMYK conversion processing, tone reduction processing, and image conversion processing on the print data acquired by the data acquisition unit 201 and generates the ejection data for ejecting ink onto the recording medium P to form an image.

The correction unit 203 is a functional unit that applies a correction mask pattern described below to the ejection data generated by the image processing unit 202, adjusts the ink ejection timing for each nozzle in the nozzle row of the recording head 30, and corrects the ink landing position. In this case, the correction unit 203 refers to the correction mask pattern stored in the storage unit 207 and applies the correction mask pattern to the ejection data.

Details of the operation of the correction unit 203 are described in the following. As illustrated in FIG. 7(a), the recording head 30 includes the nozzle row in which the plurality of nozzles N are arranged in the sub scanning direction, as described above. The ink is ejected from each nozzle N, and the dot formed by the ink landing on the recording medium P is referred to as the dot D. FIG. 7(b) illustrates a normal mask pattern MP1 applied to the ejection data. In order to simplify the description, the number of nozzles in the nozzle row is assumed as four (nozzles N1 to N4), and the number of pixels (number of dots) in the main scanning direction of the ejection data is assumed as four. Therefore, the mask pattern MP1 is a 4×4 matrix, as illustrated in FIG. 7(b), where each row corresponds to a nozzle N1 to N4, and each column indicates order of ink ejection. The value of each element of this mask pattern MP1 includes two values, 0 (no ejection) or 1 (ejection), as illustrated in the mask data in FIG. 7(c). By applying this mask pattern MP1 to the ejection data, ink is ejected according to the pixel value of the ejection data corresponding to 1 (ejection) of the mask pattern MP1, and the ink is not ejected according to the pixel value of the ejection data corresponding to 0 (no ejection) of the mask pattern MP1. Controlling whether to eject the ink is performed by applying the mask pattern MP1 to the ejection data, but in the case there are variation in the ejection characteristics or formation positions for each nozzle N in the nozzle row of the recording head 30, the ink dots D ejected at the same timing from each nozzle N of the nozzle row of the recording head 30 are not lined up in the straight line in the sub scanning direction, resulting in the deviation in the landing positions as illustrated in FIG. 7(d). In the example illustrated in FIG. 7(d), the ink dot D ejected from the nozzle N2 is ejected at a slightly earlier timing than the nozzle N1, so the landing position is slightly ahead of the nozzle N1, and since the ink dot D ejected from the nozzle N4 is ejected at an earlier timing than the nozzle N1, the landing position is deviated.

On the other hand, in the present embodiment, a correction mask pattern MP illustrated in FIG. 7(e) is used instead of the above-described mask pattern MP1. As illustrated in FIG. 7(e), the correction mask pattern MP is a 4×4 matrix, where each row corresponds to the nozzle N1 to N4, and each column indicates the order of ink ejection. In the present embodiment, the value of each element of the correction mask pattern MP is multi-valued into a 2-bit value. There are four values to each element of the correction mask pattern MP which are, 00 (no ejection), 01 (drive waveform (1) (0 ms delay)), 10 (drive waveform (2) (1 ms delay)), and 11 (drive waveform (3) (2 ms delay)) as illustrated in the mask data in FIG. 7(f).

The correction unit 203 applies the correction mask pattern MP to the ejection data. Accordingly, the ejection control unit 204 controls to eject ink corresponding to the pixel value of the ejection data, according to the value of the element of the correction mask pattern MP corresponding to the pixel value as described below. In the case the value of the element is 01 (drive waveform (1) (0 ms delay)), the ejection control unit 204 ejects ink with a drive waveform without delay, as illustrated in FIG. 8. In the case the value of the element is 10 (drive waveform (2) (1 ms delay)), the ejection control unit 204 ejects ink with a drive waveform whose timing is delayed by 1 ms, as illustrated in FIG. 8. In the case the value of the element is 11 (drive waveform (3) (2 ms delay)), the ejection control unit 204 ejects ink with a drive waveform whose timing is delayed by 2 ms, as illustrated in FIG. 8. The ejection control unit 204 does not eject ink in the case the value of the element is 00 (no ejection). The correction unit 203 corrects variation in the ejection characteristics or formation positions of each nozzle N in the nozzle row of the recording head 30 by applying the correction mask pattern MP to the ejection data. As illustrated in FIG. 7(g), ink dots D ejected at the same timing from each nozzle N in the nozzle row of the recording head 30 are arranged in a straight line in the sub-scanning direction, and deviation in landing position of each nozzle is corrected. Specifically, after the correction, the timing of ink ejection by nozzle N2 is delayed by 1 ms, and the timing of ink ejection by nozzle N4 is delayed by 2 ms as illustrated in FIG. 7(g) and as a result of the delay, the dots D of ink ejected from each nozzle at the same timing are lined up in a straight line in the sub scanning direction. Note that in the example of the correction mask pattern illustrated in FIG. 7(e), each element has the multi-value of 2-bits, but the value is not limited to this example, and values of 3 bits or more may be used resulting in detailed types of drive waveforms to be applied.

Furthermore, in the above description, as an example of changing the manner of the ink ejection, the timing of ink ejection is adjusted by adding a delay to the drive waveform, corresponding to the values of the elements of the correction mask pattern as illustrated in FIG. 8. However, the present disclosure is not limited to this example. For example, the shape of the drive waveform of the voltage applied to the recording head 30 may be changed corresponding to the values of the elements of the correction mask pattern, as an example of changing the manner of the ink ejection. For example, variation in the diameter of ink droplets caused by variation in the diameter of nozzles formed in the recording head 30 is corrected. Furthermore, as an example of changing the manner of the ink ejection, both the timing of ink ejection and the shape of the drive waveform may be adjusted by the values of the elements of the correction mask pattern.

Referring again to FIG. 6, further description is given below.

The ejection control unit 204 is a functional unit that causes ink to be ejected from each nozzle of the recording head 30 onto the recording medium P through the print controller 106 based on the ejection data to which the correction mask pattern has been applied by the correction unit 203. In other words, the ejection control unit 204 causes the ink corresponding to the pixel value of the ejection data to be ejected in accordance with the value of the element of the correction mask pattern corresponding to the pixel value, as described above.

The movement control unit 205 is a functional unit that controls movement of the carriage 20 according to the ejection data in the main scanning direction through the main scanning driver 107 and in the sub scanning direction by the sub scanning driver 110.

The setting unit 206 is a functional unit that sets the values of each element of the correction mask pattern through operations on the control panel 120 or the PC 2. The setting unit 206 causes the storage unit 207 to store set correction mask pattern. Regarding the deviation in the landing position of the ink ejected from each nozzle of the nozzle row of the recording head 30 (the deviation in the main scanning direction), for example, the deviation may be obtained by printing and checking a chart for checking the deviation in advance. Alternatively, the image forming apparatus 1 is provided with a reading device that reads the printed chart, and the amount of deviation in the landing positions may be automatically obtained based on the data read by the reading device. For example, the mask data to be associated with each dot is determined based on the obtained landing position shift, and a correction mask pattern is set by the setting unit 206. For example, the setting unit 206 automatically sets the correction mask pattern from the read data indicating the above-mentioned deviation of the landing position.

The storage unit 207 is a functional unit that stores the correction mask pattern set by the setting unit 206. The storage unit 207 is implemented by the RAM 103 or the NVRAM 104 illustrated in FIG. 3.

The data acquisition unit 201, the image processing unit 202, the correction unit 203, the ejection control unit 204, the movement control unit 205, and the setting unit 206 described above are implemented by, for example, executing a program by the CPU 101 illustrated in FIG. 3. Note that some or all of these functional units may be implemented not by a software program but by a hardware circuit (integrated circuit) such as a field-programmable gate array (FPGA) or an application specific integrated circuit (ASIC).

Further, each functional unit of the image forming apparatus 1 illustrated in FIG. 6 conceptually illustrates a function and is not limited to such a configuration. For example, a plurality of functional units illustrated as independent functional units in the image forming apparatus 1 illustrated in FIG. 6 may be configured as one functional unit. On the other hand, in the information processing apparatus 1 illustrated in FIG. 6, function of one functional unit may be divided into a plurality of units to be configured as a plurality of functional units.

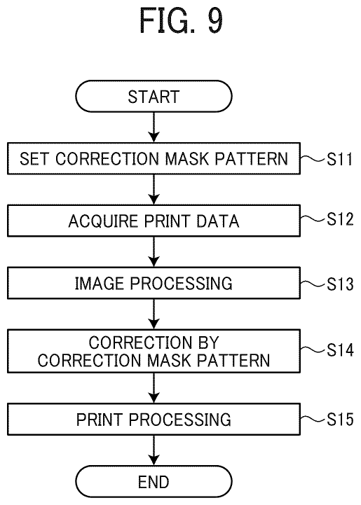

FIG. 9 is a flow chart illustrating an example of an overall operation of the image forming apparatus according to the present embodiment. The overall operation of the image forming apparatus 1 according to the present embodiment is described with reference to FIG. 9.

### Step S11

The setting unit 206 of the image forming apparatus 1 sets the value of each element of the correction mask pattern through the operation on the control panel 120 or the operation on the PC 2 and stores the correction mask pattern in the storage unit 207. Then, the process proceeds to step S12.

### Step S12

The data acquisition unit 201 of the image forming apparatus 1 acquires print data from the PC 2 through the communication OF 109. Then, the process proceeds to step S13.

### Step S13

The image processing unit 202 of the image forming apparatus 1 performs the predetermined data processing such as CMYK conversion processing, tone reduction processing, and image conversion processing on the print data acquired by the data acquisition unit 201 and generates ejection data for ejecting ink onto the recording medium P to form an image. Then, the process proceeds to step S14.

### Step S14

The correction unit 203 of the image forming apparatus 1 applies the correction mask pattern stored in the storage unit 207 to the ejection data generated by the image processing unit 202. Then, the process proceeds to step S15.

### Step S15

The ejection control unit 204 of the image forming apparatus 1 performs the printing process by ejecting ink onto the recording medium P from each nozzle of the recording head 30 through the print controller 106 based on the ejection data to which the correction mask pattern is applied by the correction unit 203. Here, the movement control unit 205 of the image forming apparatus 1 controls the movement of the carriage 20 in the main scanning direction through the main scanning driver 107 and in the sub scanning direction through the sub scanning driver 110 based on the ejection data. In other words, the ejection control unit 204 and the movement control unit 205 operate in cooperation with each other based on the ejection data. As a result, the ink ejection timing is adjusted for each nozzle in the nozzle row of the recording head 30, and the ink landing position is corrected.

As described above, in the image forming apparatus 1 according to the present embodiment, the data acquisition unit 201 acquires the print data, the image processing unit 202 converts the print data acquired by the data acquisition unit 201 into the ejection data for causing the recording head 30 to eject ink, the correction unit 203 applies, to the ejection data, the correction mask pattern that changes the manner of the ink ejection for each nozzle in the nozzle row made up of a plurality of nozzles lined up in the sub scanning direction of the recording head 30, the ejection control unit 204 causes each nozzle of the recording head 30 to eject ink onto the recording medium P based on the ejection data to which the correction mask pattern has been applied. As a result, the ink dots D ejected at the same timing from each nozzle N of the nozzle row of the recording head 30 are aligned in a straight line in the sub scanning direction, and deviation in landing position of each nozzle is corrected.

Further, in the image forming apparatus 1 according to the present embodiment, the correction unit 203 also applies a correction mask pattern that changes the timing of ink ejection to each nozzle in the nozzle row of the recording head 30. Accordingly, variation in ejection characteristics, formation positions, and the like of each nozzle in the nozzle row of the recording head 30 is corrected.

Further, in the image forming apparatus 1 according to the present embodiment, the correction unit 203 also applies a correction mask pattern that changes the drive waveform of the voltage applied to the recording head 30 for ejecting ink to each nozzle in the nozzle row of the recording head 30. Accordingly, variation in the diameter of ink droplets caused by variation in the diameter of nozzles formed in the recording head 30 is corrected.

The image forming apparatus 1 according to a modification 1 is described with a focus on the differences from the image forming apparatus 1 according to the present embodiment. The overall configuration, hardware configuration, and functional block configuration of the image forming apparatus 1 according to the present modification are the same as those described in the above embodiment.

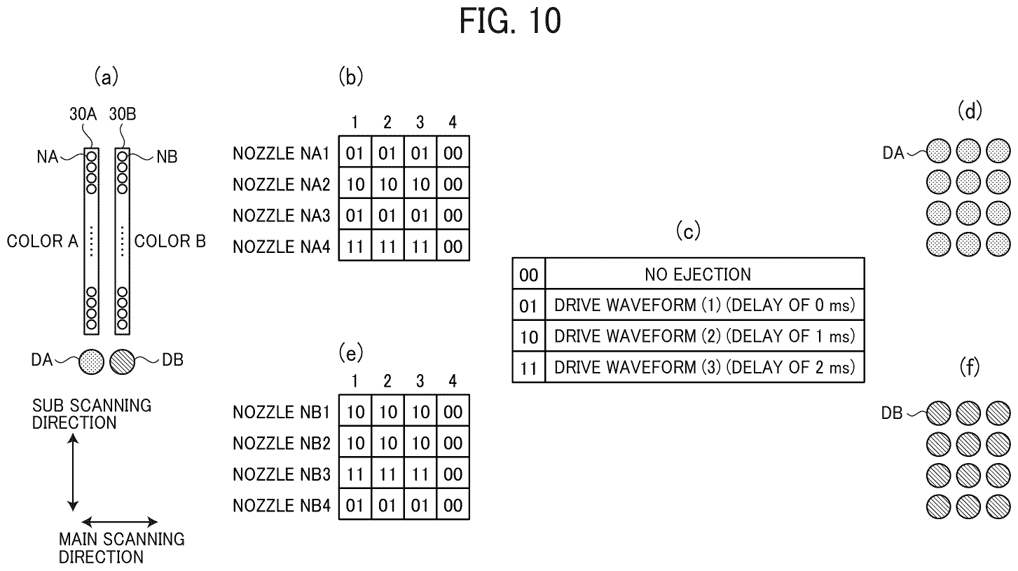

FIG. 10 is a diagram illustrating an operation of correcting the deviation in the ink landing position in the image forming apparatus according to modification 1 of the present disclosure. With reference to FIG. 10, the operation of correcting the deviation of the ink landing position in the image forming apparatus 1 according to the present modification is described below.

For example, as illustrated in FIG. 10(a), the image forming apparatus 1 according to the present modification includes a recording head 30A mounted on the carriage 20 that ejects color A ink, and a recording head 30B that ejects color B ink. The recording head 30A includes a nozzle row in which a plurality of nozzles NA are arranged in the sub scanning direction. The recording head 30B includes a nozzle row in which a plurality of nozzles NB are arranged in the sub scanning direction. The ink ejected from each nozzle NA and each nozzle NB and dots formed by the ink landing on the recording medium P is referred to as dots DA and dots DB, respectively.

In the present modification, the image forming apparatus 1 uses a correction mask pattern illustrated in FIG. 10(b) for the recording head 30A that ejects color A ink, and a correction mask pattern illustrated in FIG. 10(e) for the recording head 30B that ejects color B ink. The correction mask pattern illustrated in FIG. 10(b) is a 4×4 matrix, where each row corresponds to a nozzle NA1 to NA4, and each column indicates the order of ink ejection. The correction mask pattern illustrated in FIG. 10(e) is a 4×4 matrix, where each row corresponds to a nozzle NB1 to NB4, and each column indicates the order of ink ejection. In the present modification, as an example, the values of each element of these correction mask patterns are multi-valued with 2-bit values. There are four values to each element of the correction mask pattern which are, 00 (no ejection), 01 (drive waveform (1) (0 ms delay)), 10 (drive waveform (2) (1 ms delay)), and 11 (drive waveform (3) (2 ms delay)) as illustrated in mask data in FIG. 10(c).

The correction unit 203 applies a correction mask pattern illustrated in FIG. 10(b) to a portion of the ejection data corresponding to the recording head 30A, and a correction mask pattern illustrated in FIG. 10(e) to a portion of the ejection data corresponding to the recording head 30B. Accordingly, the ejection control unit 204 ejects ink corresponding to the pixel value of the ejection data according to the value of the element of the correction mask pattern corresponding to the pixel value. For example, in the case the value of the element is 01 (drive waveform (1) (0 ms delay)), the ejection control unit 204 ejects ink using a drive waveform without delay, as illustrated in FIG. 8 described above. Further, in the case the value of the element is 10 (drive waveform (2) (1 ms delay)), the ejection control unit 204 ejects ink using a drive waveform with a timing delayed by 1 ms as illustrated in FIG. 8 described above. Further, in the case the value of the element is 11 (drive waveform (3) (2 ms delay)), the ejection control unit 204 ejects ink using the drive waveform with a timing delayed by 2 ms as illustrated in FIG. 8 described above. The ejection control unit 204 does not eject ink in the case the value of the element is 00 (no ejection). In this way, the correction unit 203 applies different correction mask patterns to the ejection data for each ink color, so that variation in the ejection characteristics or formation positions for each nozzle in the nozzle rows of the recording heads 30A and 30B are corrected, and as illustrated in FIGS. 10(d) and 10(f), in the recording heads 30A and 30B, ink dots DA and DB ejected at the same timing from each nozzle N in the nozzle row are aligned straight in the sub scanning direction, and deviation in landing position for each nozzle for each ink color is corrected. This improves accuracy of multi-color ink landing positions.

Note that the present disclosure is not limited to applying a different correction mask pattern for each ink color, and a different correction mask pattern may be applied for each recording head 30 or for each nozzle row of the recording head 30.

The image forming apparatus 1 according to a modification 2 is described with a focus on the differences from the image forming apparatus 1 according to the present embodiment. The overall configuration, hardware configuration, and functional block configuration of the image forming apparatus 1 according to the present modification are the same as those described in the above embodiments.

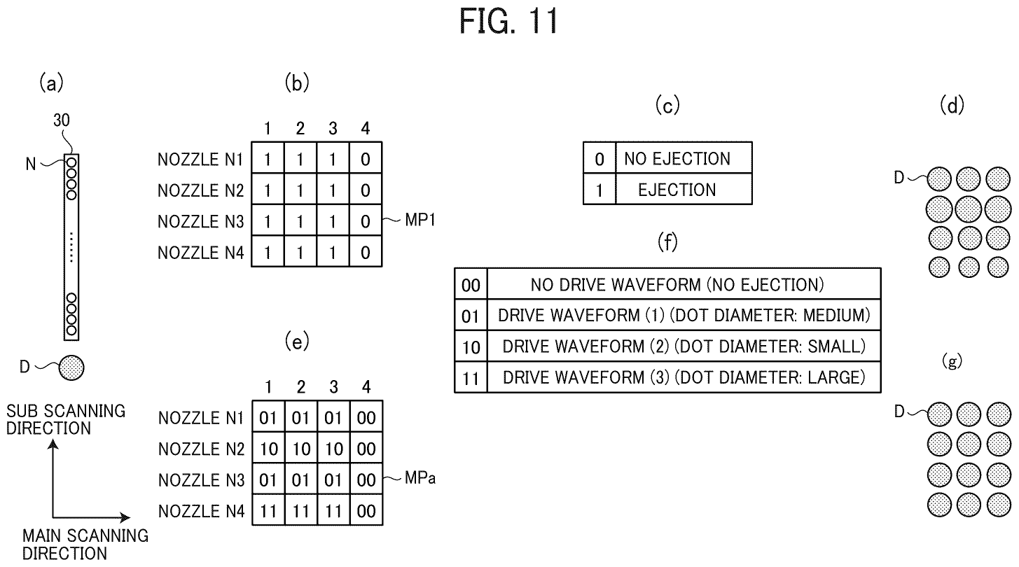

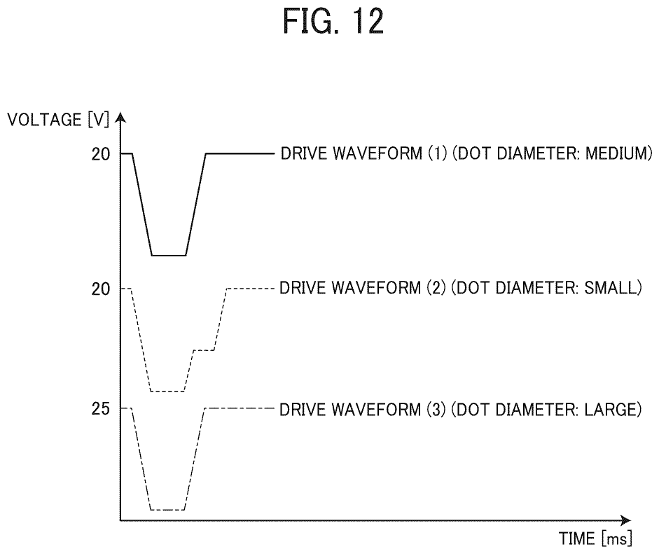

FIG. 11 is a diagram illustrating an operation for correcting variation in ink diameter in the image forming apparatus according to the modification 2. FIG. 12 is a diagram illustrating an example of a recording head drive waveform used to correct variation in ink diameter in the image forming apparatus according to the modification 2. The details of the operation of the correction unit 203 of the image forming apparatus 1 according to the present embodiment is described with reference to FIGS. 11 and 12.

As illustrated in FIG. 11(a), the recording head 30 includes a nozzle row in which a plurality of nozzles N are arranged in the sub scanning direction. FIG. 11(b) illustrates a normal mask pattern MP1 applied to the ejection data. In order to simplify the description, the number of nozzles in the nozzle row is assumed as four (nozzles N1 to N4), and the number of pixels (number of dots) in the main scanning direction of the ejection data is four. Accordingly, the mask pattern MP1 is a 4×4 matrix, as illustrated in FIG. 11(b), where each row corresponds to a nozzle N1 to N4, and each column indicates the order of ink ejection. The value of each element of this mask pattern MP1 includes two values, 0 (no ejection) or 1 (ejection), as illustrated in the mask data in FIG. 11(c).

By applying this mask pattern MP1 to the ejection data, ink is ejected according to the pixel value of the ejection data corresponding to 1 (ejection) of the mask pattern MP1, and the ink is not ejected according to the pixel value of the ejection data corresponding to 0 (no ejection) of the mask pattern MP1. By applying the mask pattern MP1 to the ejection data, whether or not to eject is controlled, but in the case there is variation in the nozzle diameter and the like of each nozzle N in the nozzle row of the recording head 30, variation is caused in the diameters of ink dots D ejected at the same timing from each nozzle N of the nozzle row of the recording head 30, as illustrated in FIG. 11(d). In the example illustrated in FIG. 11(d), the diameter of the ink dot D ejected from the nozzle N2 is larger than the diameter of the ink dot D ejected from the nozzles N1 and N3, and the diameter of the ink dot D ejected from the nozzle N4 is smaller than the diameter of the ink dot D ejected from the nozzles Ni and N3.

On the other hand, in the present modification, a corrected mask pattern MPa illustrated in FIG. 11(e) is used instead of the above-described mask pattern MP1. The correction mask pattern MPa is a 4×4 matrix, as illustrated in FIG. 11(e), where each row corresponds to a nozzle N1 to N4, and each column indicates the order of ink ejection. In the present modification, the value of each element of this correction mask pattern MPa is multi-valued into a 2-bit value. That is, the value of each element of the correction mask pattern MPa is 00 (no drive waveform (no ejection)), 01 (drive waveform (1) (dot diameter: middle)), 10 (drive waveform (2) (dot diameter: small)), and 11 (drive waveform (3) (dot diameter: large)).

The correction unit 203 applies the correction mask pattern MPa to the ejection data. Thereby, the ejection control unit 204 ejects ink corresponding to the pixel value of the ejection data according to the value of the element of the correction mask pattern corresponding to the pixel value. In the case the value of the element is 01 (drive waveform (1) (dot diameter: medium)), the ejection control unit 204 ejects ink using a drive waveform with a medium dot diameter, as illustrated in FIG. 12. In the case the value of the element is 10 (drive waveform (2) (dot diameter: small)), the ejection control unit 204 ejects ink using a drive waveform that makes the dot diameter small, as illustrated in FIG. 12. In the case the value of the element is 11 (drive waveform (3) (dot diameter: large)), the ejection control unit 204 ejects ink using a drive waveform that increases the dot diameter, as illustrated in FIG. 12. Further, the ejection control unit 204 does not eject ink in the case the value of the element is 00 (no drive waveform (no ejection)). By applying the correction mask pattern MPa to the ejection data, the correction unit 203 corrects variation in the nozzle diameter and the like for each nozzle N in the nozzle row of the recording head 30, and as illustrated in FIG. 11(g), dots D of ink ejected with the same ejection amount from each nozzle N of the nozzle row of the recording head 30 are aligned in a straight line in the sub scanning direction and variation in the diameter of ink dots D is corrected for each nozzle. Specifically, after the correction, nozzle N2 ejects ink to form the dots with smaller diameters and nozzle N4 ejects ink to form the dots with larger diameters as illustrated in FIG. 11(g). As a result, the diameters of the ink dots D ejected from each nozzle at the same amount are uniform.

In addition, in the example of the correction mask pattern illustrated in FIG. 11(e), each element has multi-value of 2-bits, but the value is not limited to this example, and a finer type of drive waveform is enabled by setting the value to 3 bits or more.

As described above, in the image forming apparatus 1 according to the present modification, the correction unit 203 is also able to apply the correction mask pattern that changes the drive waveform of the voltage applied to the recording head 30 for ejecting ink to each nozzle in the nozzle row of the recording head 30. Accordingly, variation in the diameter of ink dots caused by variation in the diameter of nozzles formed in the recording head 30 and the like is corrected.

In addition, as an example of changing the manner of ink ejection by the value of the element of the correction mask pattern, both the ink ejection timing described in FIGS. 7 and 8 of the embodiment described above and the diameter of the ink dot described in the present modification may be adjustable.

Note that in the embodiment described above and each modification, when at least one of the functions of the image forming apparatus 1 or the PC 2 is implemented by executing a program, the program is provided by being pre-installed in a ROM or the like. Further, in the embodiment described above and each modification, the programs executed by the information processing apparatus 1 or the PC 2 may be provided by being recorded in a computer-readable recording medium such as a compact disc read only memory (CD-ROM), a flexible disk (FD), a compact disc-recordable (CD-R), a digital versatile disc (DVD), or a secure digital (SD) card as a file in an installable format or an executable format.

Further, in the embodiment described above and each modification, the program executed by the image forming apparatus 1 and the PC 2 may be stored on a computer connected to a network such as the internet, and provided by being downloaded through the network. Furthermore, in the embodiment described above and each modification, the programs executed by the image forming apparatus 1 and the PC 2 may be configured to be provided or distributed through a network such as the internet. The program executed in the image forming apparatus 1 and the PC 2 according to the embodiment described above has a module configuration including at least one of the above-described functional units. As actual hardware, the CPU reads the program from the above-described storage device and executes the program, whereby the above-described functional units are loaded onto the main storage device and generated.

Aspects of the present disclosure are, for example, as follows.

According to a first aspect, an image forming apparatus to form an image by ejecting ink from a recording head onto a recording medium includes, an acquisition unit to acquire print data, a conversion unit to convert the print data acquired by the acquisition unit into ejection data to cause a recording head to eject ink, a correction unit to apply to the ejection data, a correction mask pattern to change a manner of ink ejection for each nozzle of a nozzle row made up of a plurality of nozzles lined up in sub scanning direction of the recording head, and an ejection control unit to cause each nozzle of the recording head to eject ink onto the recording medium based on the ejection data to which the correction mask pattern is applied.

According to a second aspect, in the image forming apparatus of the first aspect, the correction unit applies the correction mask pattern to change timing of ink ejection to each nozzle of the nozzle row of the recording head.

According to a third aspect, in the image forming apparatus of the first aspect, the correction unit applies the correction mask pattern to change a drive waveform of voltage applied to the recording head to eject ink, to each nozzle of the nozzle row of the recording head.

According to a fourth aspect, in the image forming apparatus of any one of the first aspect to the third aspect, further includes a setting unit to set the correction mask pattern according to an operation input, a storage unit to store the correction mask pattern set by the setting unit, and the correction unit applies the correction mask pattern stored in the storage unit to the ejection data.

According to a fifth aspect, in the image forming apparatus of any one of the first aspect to the fourth aspect, the correction unit applies a different correction mask pattern for each color of ink ejected from the recording head.

According to a sixth aspect, in the image forming apparatus of any one of the first aspect to the fourth aspect, wherein the recording heads are plural, and the correction unit applies a different correction mask pattern to each recording head.

According to a seventh aspect, in the image forming apparatus of any one of the first aspect to the fourth aspect, the correction unit applies a different correction mask pattern to each nozzle row of the recording head.

According to an eighth aspect, an image forming method in which an image is formed by ejecting ink from a recording head onto a recording medium, includes, an acquisition step to acquire print data, a conversion step to convert the print data acquired by the acquisition unit into ejection data to cause a recording head to eject ink, a correction step to apply to the ejection data, a correction mask pattern to change a manner of ink ejection for each nozzle of a nozzle row made up of a plurality of nozzles lined up in sub scanning direction of the recording head, and an ejection control step to cause each nozzle of the recording head to eject ink onto the recording medium based on the ejection data to which the correction mask pattern is applied.

According to a ninth aspect, a program to cause a computer to control an image forming apparatus to form an image by ejecting ink from a recording head onto a recording medium to perform, an acquisition step to acquire print data, a conversion step to convert the print data acquired by the acquisition unit into ejection data to cause a recording head to eject ink, a correction step to apply to the ejection data, a correction mask pattern to change a manner of ink ejection for each nozzle of a nozzle row made up of a plurality of nozzles lined up in sub scanning direction of the recording head, and an ejection control step to cause each nozzle of the recording head to eject ink onto a recording medium based on the ejection data to which the correction mask pattern is applied.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image forming apparatus comprising:
a recording head to eject ink onto a recording medium to form an image thereon; and
circuitry configured to:
acquire print data;
convert the print data into ejection data to be used by the recording head to eject ink;
apply, to the ejection data, a correction mask pattern to change a manner of ink ejection for each nozzle of a nozzle row, the nozzle row including a plurality of nozzles arranged in a sub scanning direction of the recording head; and
cause each nozzle of the recording head to eject ink onto the recording medium based on the ejection data to which the correction mask pattern is applied.

2. The image forming apparatus of claim 1, wherein
the circuitry is configured to apply the correction mask pattern to change timing of ink ejection to each nozzle of the nozzle row of the recording head.

3. The image forming apparatus of claim 1, wherein
the circuitry is configured to apply the correction mask pattern to change a drive waveform of voltage applied to the recording head to eject ink, to each nozzle of the nozzle row of the recording head.

4. The image forming apparatus of claim 1, wherein
the circuitry is configured to:
set the correction mask pattern according to an operation input;
store the correction mask pattern in one or more memories; and
apply the correction mask pattern that is stored to the ejection data.

5. The image forming apparatus of claim 1, wherein
the circuitry is configured to apply the correction mask pattern that differs depending on a color of ink ejected from the recording head.

6. The image forming apparatus of claim 1, further comprising:
a plurality of recording heads including the recording head,
wherein the circuitry is configured to apply a plurality of correction mask patterns that are different from each other, respectively to the plurality of recording heads.

7. The image forming apparatus of claim 1, wherein
the circuitry is configured to apply the correction mask pattern that differs depending on a nozzle row of the recording head.

8. An image forming method, performed by an image forming apparatus, comprising:
acquiring print data;
converting the print data into ejection data to be used by a recording head of the image forming apparatus to eject ink;
applying, to the ejection data, a correction mask pattern to change a manner of ink ejection for each nozzle of a nozzle row, the nozzle row including a plurality of nozzles arranged in sub scanning direction of the recording head; and
causing each nozzle of the recording head to eject ink onto a recording medium based on the ejection data to which the correction mask pattern is applied, to form an image on the recording medium.

9. A non-transitory recording medium storing a plurality of instructions which, when executed by one or more processors on an image forming apparatus, causes the processors to perform an image forming method, the method comprising:
acquiring print data;
converting the print data into ejection data to be used by a recording head of the image forming apparatus to eject ink;
applying, to the ejection data, a correction mask pattern to change a manner of ink ejection for each nozzle of a nozzle row, the nozzle row including a plurality of nozzles arranged in sub scanning direction of the recording head; and
causing each nozzle of the recording head to eject ink onto a recording medium based on the ejection data to which the correction mask pattern is applied, to form an image on the recording medium.
